(19) United States
(12) Patent Application Publication
(10) Pub. No.: US 2014/0350961 A1
(43) Pub. Date: Nov. 27, 2014

(54) TARGETED SUMMARIZATION OF MEDICAL DATA BASED ON IMPLICIT QUERIES

(71) Applicant: Xerox Corporation, Norwalk, CT (US)

(72) Inventors: Gabriela Csurka, Crolles (FR); Mario Agustin Ricardo Jarmasz, Meylan (FR); Florent C. Perronnin, Domene (FR); Juan Antonio Lossio Ventura, Montpellier (FR)

(73) Assignee: Xerox Corporation, Norwalk, CT (US)

(21) Appl. No.: 13/898,805

(22) Filed: May 21, 2013

(51) Int. Cl. G06F 19/00

(52) U.S. Cl. CPC G06F 19/322
USPC 705/3

(57) ABSTRACT

A system and method for targeted summarization of a patient's electronic medical records are provided. The system includes an aggregation component which provides an aggregation of health records of a patient. A transformation component transforms the health records of the patient into representations in a multidimensional search space. A search component generates an implicit query in the multidimensional search space and retrieves responsive heath records based on the implicit query. A summarization component generates a summary based on the retrieved responsive health records for display to a healthcare provider on an associated user interface. A processor implements the aggregation component, transformation component, search component, and summarization component.

### BACKGROUND

The exemplary embodiment relates to the summarization of medical data and finds particular application in connection with a system and method which use implicit and optionally explicit queries to generate a summary of medical data which is useful to a medical practitioner.

Electronic medical records (EMR) are computerized medical records that are often created in an organization that delivers care, such as a hospital or physician's office. When different sources of medical information are shared over a health care network, these are often referred to as electronic health records (EHR) and may include a range of data, including medical history, current and past medications and allergies, immunizations, laboratory test results, radiology images, vital signs, personal statistics, such as age and weight, and the like. For purposes herein, both EMR and EHR are considered to be EMR unless otherwise noted. A personal health record (PHR) is a patient-specific EMR, relating to a single person.

The increasing adoption of EMRs for storing PHRs, improvements in medical imaging technologies, the availability of mobile wellness applications and connected sensor devices (for example scales, blood pressure monitors and glucose meters) is producing enormous quantities of electronic medical data. Even the records of a single patient may occupy several gigabytes of data. Increases in storage and computing power have greatly improved the quality and quantity of medical data collected, especially for medical imaging devices. However, aggregating and searching medical data remains difficult, due to the quantity of data and different formats used. As a consequence, many doctors commonly rely solely on their clinical knowledge about a given case to make a decision rather than by reviewing the patient's entire medical history. In some cases, this can result in misdiagnosis and missed diagnoses.

The type of medical information stored in EMRs has undergone a certain amount of standardization. The healthcare industry has attempted to facilitate this by imposing standards for encoding and sharing data. The type of medical information which can be stored and how it is encoded and shared have been defined and accepted in several countries. As examples, HL7 (a standardized messaging and text communications protocol between hospital and physician record systems, and practice management systems), CDA (Clinical Document Architecture), CCR (the ASTM International Continuity of Care Record standard) ANSI X12 (EDI) (transaction protocols used for transmitting patient data), and XDS, (Cross-enterprise Document Sharing) are able to bring some level of uniformity. Software vendors have also worked closely with governments to define how medical information should be displayed so as to make it easier for caregivers to find the right information in systems containing electronic medical records. As an example, the Microsoft Health Common User Interface (MSCUI) provides a standardized toolkit for design of graphical user interfaces for healthcare applications.

In practice, however, medical data is unstructured and contains a variety of highly heterogeneous information, such as narrative text, immunization histories, allergies, lab results, prescriptions, radiology images, treatment plans, healthcare workers notes, and so forth.

There remains a need for a system which retrieves and displays relevant information to help physicians, nurses, surgeons and other health care providers make more informed decisions in a timely manner.

### INCORPORATION BY REFERENCE

The following references, the disclosures of which are incorporated herein by reference in their entireties, are mentioned:

The following relate generally to the processing and accessing of electronic medical records: U.S. Pat. No. 8,219,515, issued Jul. 10, 2012, entitled VISUALIZATION OF DATA RECORD PHYSICALITY, by Jordan, et al.; U.S. Pat. No. 8,239,218, issued Aug. 7, 2012, entitled METHOD AND APPARATUS FOR PROVIDING A CENTRALIZED MEDICAL RECORD SYSTEM, by Madras, et al.; U.S. Pat. No. 8,121,855, issued Feb. 21, 2012, entitled METHOD AND SYSTEM FOR PROVIDING ONLINE MEDICAL RECORDS, by Robert H. Lorsch; U.S. Pat. No. 7,664,661, issued Feb. 16, 2010, entitled ELECTRONIC METHOD AND SYSTEM THAT IMPROVES EFFICIENCIES FOR RENDERING DIAGNOSIS OF RADIOLOGY PROCEDURES, by Schwalb, et al.; U.S. Pat. No. 7,533,030, issued May 12, 2009, entitled METHOD AND SYSTEM FOR GENERATING PERSONAL/INDIVIDUAL HEALTH RECORDS, by Hasan, et al.; U.S. Pat. No. 7,509,264, issued Mar. 24, 2009, entitled METHOD AND SYSTEM FOR GENERATING PERSONAL/INDIVIDUAL HEALTH RECORDS, by Hasan, et al.; U.S. Pub. No. 20120310666 published Dec. 6, 2012, entitled PERSONALIZED MEDICAL RECORD, by Xu, et al.; U.S. Pub. No. 20110119089, published May 19, 2011, entitled SYSTEM AND METHOD FOR PERSONAL ELECTRONIC MEDICAL RECORDS, by Jeffrey A. Carlisle; U.S. Pub. No. 20100257214, published Oct. 7, 2010, entitled MEDICAL RECORDS SYSTEM WITH DYNAMIC AVATAR GENERATOR AND AVATAR VIEWER, by Luc Bessette; U.S. Pub. No. 20090299977, published Dec. 3, 2009, entitled METHOD FOR AUTOMATIC LABELING OF UNSTRUCTURED DATA FRAGMENTS FROM ELECTRONIC MEDICAL RECORDS, by Romer E. Rosales; U.S. Pub. No. 20080154643, published Jun. 26, 2008, entitled SYSTEM AND METHOD FOR PATIENT MANAGEMENT OF PERSONAL HEALTH, by Mauricio A. Leon; U.S. Pub. No. 20070198301, published Aug. 23, 2007, entitled METHOD AND SYSTEM FOR REPRESENTATION OF CURRENT AND HISTORICAL MEDICAL DATA, by Ayers, et al.

U.S. Pat. No. 8,219,557, issued Jul. 10, 2012, ENTITLED SYSTEM FOR AUTOMATICALLY GENERATING QUERIES, by Grefenstette, et al., relates to the generation of queries.

### BRIEF DESCRIPTION

In accordance with one aspect of the exemplary embodiment, a system for targeted summarization of a patient's electronic medical records is provided. The system includes an aggregation component which provides an aggregation of health records of a patient. A transformation component transforms the health records of the patient into representations in a multidimensional search space. A search component generates an implicit query in the multidimensional search space and retrieves responsive heath records based on the implicit query. A summarization component generates a summary based on the retrieved responsive health records for display to a healthcare provider on an associated user interface. A processor implements the aggregation component, transformation component, search component, and summarization component.

In another aspect of the exemplary embodiment, a method for targeted summarization of a patient's electronic medical records, includes providing an aggregation of health records of a patient, transforming the health records of the patient into representations in a multidimensional search space, generating an implicit query in the multidimensional search space, retrieving responsive heath records based on the implicit query, generating a summary based on the retrieved responsive health records for display to a healthcare provider on a user interface. At least one of the providing an aggregation, transformation, implicit query generation, retrieval, and summary generation may be implemented by a computer processor.

In another aspect of the exemplary embodiment, a method for targeted summarization of a patient's electronic medical records includes accessing health records of a patient. Each of a collection of health records of the patient is transformed into at least one multidimensional representation based on an ontology of medical concepts. At least some of the concepts in the ontology being linked by relationship links that are used to identify related concepts. An implicit query is generated including a multidimensional representation based on the ontology of medical concepts. The multidimensional representation of the query is compared with the multidimensional representations of the health records of the patient to identify a set of similar heath records based on the comparison. The set of similar heath records is summarized to generate a graphical rendering of the similar heath records for display to the healthcare provider on a user interface.

At least one of the accessing, transformation, implicit query generation, comparison, and summary generation may be implemented by a computer processor.

### BRIEF DESCRIPTION OF THE DRAWINGS

FIG. 1 is an overview of a system and method for summarization of medical data based on implicit queries;

FIG. 2 is a functional block diagram of a system for summarization of medical data based on implicit queries in accordance with one aspect of the exemplary embodiment;

FIG. 3 is a flow chart illustrating a method for summarization of medical data based on implicit queries in accordance with another aspect of the exemplary embodiment;

FIG. 4 is an example of knowledge represented in UMLS with different types of relationships; and

FIG. 5 is a visualization of the summarized information that could be retrieved for a patient with an implicit query generally corresponding to “congestive heart failure” in the patient's PHR data.

### DETAILED DESCRIPTION

The exemplary system and method for summarization of medical data are based on the principle that relevant information depends on the context. What is relevant to one specialist may be irrelevant to another specialist or to a nurse. However, searching for the relevant information explicitly is a time-consuming task. The exemplary system and method are configured to filter the medical data of a patient according to an implicit query.

As used herein, a healthcare provider can be any person involved with the use of a patient's health record (PHR), such as a medical doctor, doctor's assistant, nurse, physiotherapist, radiologist, anesthesiologist, medical practice, or the like.

A patient can be any person (or animal) for whom health records are generated.

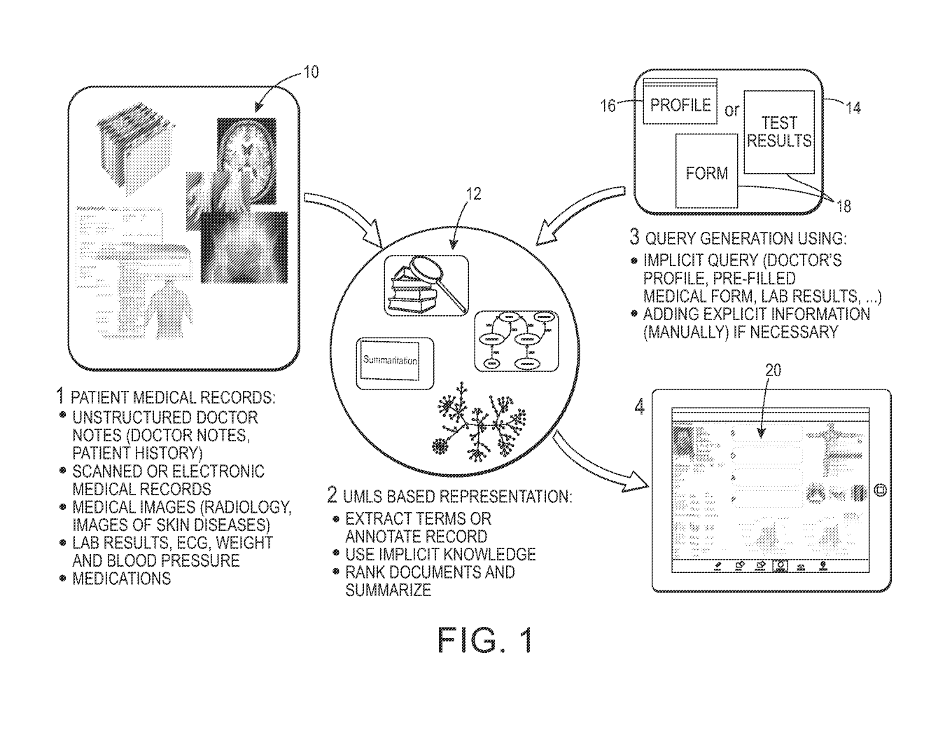

FIG. 1 graphically illustrates four stages of the exemplary system and method. A patient's health records are aggregated or otherwise linked to form a PHR 10 and stored in electronic form in computer memory. A uniform representation, based on an ontology, such as a Unified Medical Language System (UMLS) ontology, is used to generate a representation 12 of each of the patient's health records 10. For a given context, a query is generated based on relevant implicit information 14. The query may include an implicit component (implicit query) and optionally an explicit component (manual query). The implicit query is based on the automatically identified implicit information 14 that is relevant to the given context, such as a patient/healthcare provider consultation. The implicit information 14 may include one or more of the healthcare provider's profile 16 and recently acquired patient records 18, such as laboratory results, e.g., brought by the patient, a form which has been completed by the patient upon admission, or the like. The implicit query may be enriched with one or more explicit query terms based on information which may be input by the healthcare provider, such as dates or medical procedures. The query is used to access the UMLS-based representation 12 to identify relevant records, which are then retrieved from the PHR 10. The retrieved records may be further organized, summarized, and visualized to generate a graphical rendition 20 which can be displayed to the healthcare provider on a graphical user interface. The graphical rendition 20 of the retrieved records assists the healthcare provider in understanding the patient's medical records and health status faster, which in turn helps in taking appropriate actions.

The healthcare provider's profile 16 may be generated, for example using a combination of information, such as the healthcare provider's specialty, the hospital or other location where the healthcare provider is located, medical information for a set of encountered patients, and the like.

The collection of patient records 10 may include highly heterogeneous information, including records in different modalities, such as text, audio, and visual information. As illustrated in FIG. 1, examples of the types of heterogeneous medical information that a PHR 10 may contain may include one or more of:

1) stored patient information, such as name, date of birth, social insurance number, doctors, blood type, health insurance;

2) unstructured notes comprising text in a natural language, such as English, recorded by a healthcare worker, such as a healthcare provider, laboratory technician, or the like (e.g., doctor's notes, patient history, treatments, letters);

3) scanned or electronic medical records;

4) medical images (e.g., radiology images generated by a radiology device, photographic images of skin diseases, photographs taken at the various stages of a person's life);

5) numerical values (e.g., laboratory results, weight, and blood pressure values recorded by smart connected objects);

6) lists of medical terms and associated dates (immunization histories, allergies, family history);

7) current and past medications and dosages;

8) audio recordings (e.g., ECG, patient interviews);

7) eye and dental records; and

8) other information which is often stored in an unstructured manner, such as health habits, exercise regimen, family history, and the like.

The medical information in the PHR may be in the form of records, each record including one or more types of medical information.

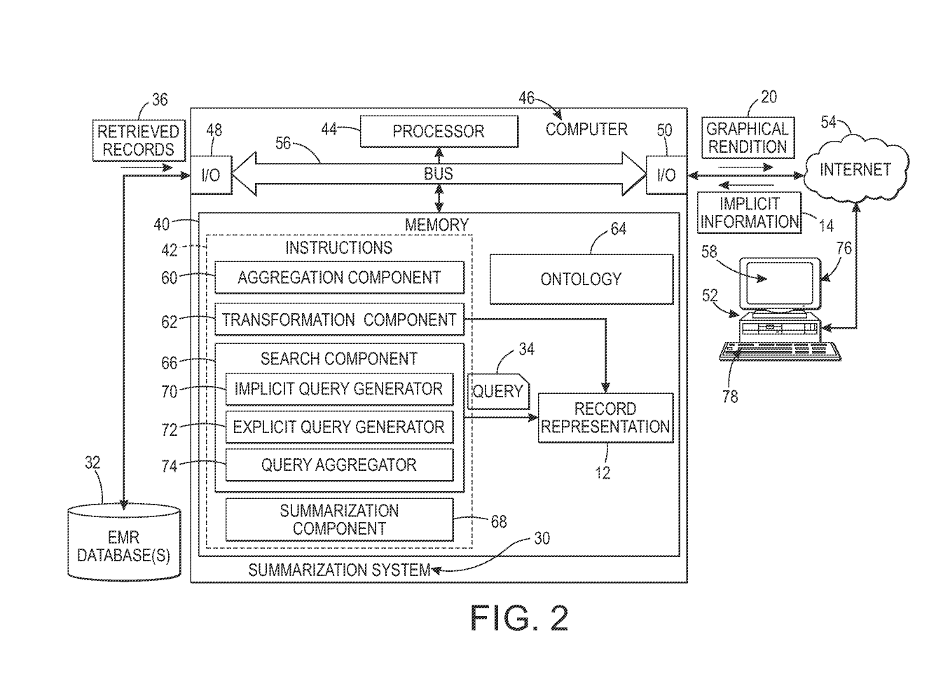

FIG. 2 illustrates one embodiment of an exemplary system 30 for targeted summarization of a patient's electronic heath (e.g., medical) records 10, as discussed in connection with FIG. 1. The exemplary system 30 has the capability to access the PHR 10 of a given patient, which may be stored in one or more non-transitory data storage devices, such as the illustrated database 32. It is assumed that any security and privacy issues are addressed. The system 30 enables the automatic creation of queries 34 to find relevant information in the PHR 10 of a given patient. It is assumed that multimodal and heterogeneous medical data of the type found in the PHR 10 can be indexed using a standardized uniform representation 12 (or “signature”). Such a representation allows defining appropriate similarity measures to be able to search the PHR, and to group and summarize the retrieved records 36.

The system includes memory 40 which stores software instructions 42 for performing the targeted summarization and a computer processor 44 in communication with the memory 40, which executes the instructions. The system 30 may be hosted by a suitable computing device 46, which includes one or more interface (I/O) devices 48, 50, for communicating with external devices, such as the illustrated medical records database 32 and a client computing device 52, e.g., via a wired or wireless network 54, such as the Internet. Hardware components 40, 44, 48, 50 of the system 30 may communicate via a data/control bus 56. A graphical user interface (GUI) 58, which may be hosted by the client device 52, displays the graphical rendition 20 of the summarized retrieved records 36. As will be appreciated, while the illustrated GUI is hosted by a computing device 52 which is remote from the system, in one embodiment, the GUI may be directly linked to the computer 46 hosting the system.

The exemplary instructions 42 include an aggregation component 60, which provides access to the medical records 10 of a patient; a transformation component 62, which transforms each element of the medical records of a patient into a homogeneous representation 12 in a search space using an ontology 64; a search component 66, which generates a query 34 in the search space and retrieves responsive medical records 36; and a summarization component 68, which generates a summary based on the retrieved responsive medical records for display to a healthcare professional on the user interface 58. The processor 44 implements the aggregation component, transformation component, search component, and summarization component.

The aggregation component 60 may aggregate all available medical data for a given patient, if it has not already been aggregated into a PHR 10. The data includes a collection of health records. The number of health records in the collection is not limited but may be for example, at least five or at least ten health records, at least some of which may be of different modalities (text, audio, image).

The transformation component 62 transforms each element of medical information (e.g., each record 36 or part of a record) into a respective multidimensional representation in a multidimensional search space.

The search component 66 builds one or more queries 34 from the implicit information 14 and searches the database 32 to retrieve relevant medical records. In the exemplary embodiment, the search component 66 includes an implicit query generator 70, which generates an implicit part of the query 34, based on the implicit information, an explicit query generator 72, which generates an explicit part of the query based on terms that are input manually by the healthcare provider, and a query aggregator 74, which aggregate the query components to generate a single query 34 comprising a single multidimensional representation in the search space. In other embodiments separate queries may be generated, in the multidimensional search space, for the implicit and explicit query components.

The summarization component 68 receives relevant medical records 36, and summarizes and visualizes them. The graphical rendition 20 thus generated may be displayed to the healthcare provider on a display device 76 of the GUI 58, such as an LCD screen, computer monitor, or the like, which may be communicatively linked to or integral with the client device 52. The GUI 58 may further include a user input device 78, such as a cursor control device, touch screen, keyboard, keypad or the like which allows the healthcare provider to interact with the graphical rendition 20.

The computer device 46 may be a server computer, a desktop, laptop, tablet, or palmtop computer, a portable digital assistant (PDA), a cellular telephone, a pager, combination thereof, or other computing device capable of executing instructions for performing the exemplary method.

The memory 40 may represent any type of non-transitory computer readable medium such as random access memory (RAM), read only memory (ROM), magnetic disk or tape, optical disk, flash memory, or holographic memory. In one embodiment, the memory 40 comprises a combination of random access memory and read only memory. In some embodiments, the processor 44 and memory 40 may be combined in a single chip. The network interface 48, 50, allows the computer 46 to communicate with other devices via a computer network 54, such as a local area network (LAN) or wide area network (WAN), or the Internet, and may comprise a modulator/demodulator (MODEM) a router, a cable, and and/or Ethernet port. Memory 40 stores instructions for performing the exemplary method as well as acquired, input relevant information 14, generated queries 34, the uniform representations 12 of the records, and the retrieved records 36, during processing.

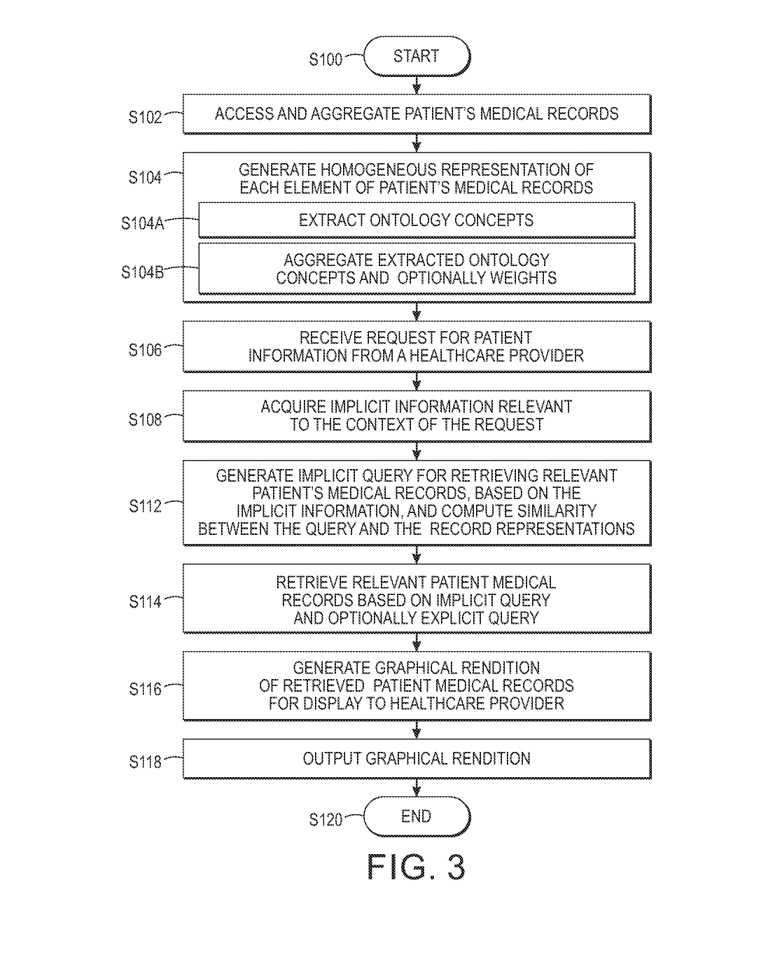

The digital processor 44 can be variously embodied, such as by a single-core processor, a dual-core processor (or more generally by a multiple-core processor), a digital processor and cooperating math coprocessor, a digital controller, or the like. The exemplary digital processor 44, in addition to controlling the operation of the computer 46, executes instructions stored in memory 40 for performing the method outlined in FIG. 3.

The client device 52 may be configured with memory and a processor, as for computing device 46, except as noted. As will be appreciated, the exemplary system 30 may be distributed over the server 46 and client device 52, or may be located on a single computing device, such as the healthcare professional's device 52.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 2 is a high level functional block diagram of only a portion of the components which are incorporated into a computer system. Since the configuration and operation of programmable computers are well known, they will not be described further.

FIG. 3 illustrates a method for summarization of medical data based on implicit queries, which may be performed with the system of FIG. 2. The method begins at S100.

At S102, all available medical data for a given patient is accessed and aggregated, if not already in the form of a PHR 10, by the aggregation component 60.

At S104, each record of the collection of medical data 10 (or its sub-parts) is transformed into a unique homogeneous multidimensional representation 12 by the transformation component 62, e.g., using the concepts of the ontology 64 as its dimensions.

At S108, a request for information about a patient is received from a healthcare provider or an assistant. In other embodiments, the request is generated automatically. The request is received by the search component 70.

At S110, implicit information 14 is acquired by the search component 70 which corresponds to the request. Provision may also be made for the healthcare provider to input explicit information for generating an explicit query or a common implicit plus explicit query.

At S112, a query 34 is built from the implicit information 14 which includes a multidimensional representation in the same search space as the record representations 12.

At S114, relevant records are retrieved from the patient's records by the search component 66, based on a measure of similarity between multidimensional representations of the records (or their sub-parts) and a corresponding multidimensional representation of the query.

At S116, a graphical rendition 20 is generated by summarizing and visualizing at least some of the retrieved records 36.

At S118, the graphical rendition 20 is output, e.g., to the user interface on the client device 52 of the healthcare provider.

The method ends at S120.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively or additionally, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method. In some embodiments, the method may be implemented partly on server computer 46 and partly on client computer 52, and/or on other linked computing devices. As will be appreciated, while the steps of the method may all be computer implemented, in some embodiments one or more of the steps may be at least partially performed manually.

Further details of the system and method will now be described.

### 1. Aggregation of all Available Medical Data (S102)

Each patient may have a respective history of medical records stored in electronic format. This data may be stored in one or more different data storage devices 32, such as a portable memory storage device, e.g., a dedicated smart card or USB key; a mobile communication device, such as a smart phone; a dedicated remote central or distributed database; or combination of data storage devices.

In one embodiment, the system 30 may access a patient's medical data using their unique ID and consent (for example, the patient gives his express consent by providing a password or a biometric identifier such as a fingerprint). In the case where a patient's records are distributed (with no one company or institution taking the responsibility of storing all health records), a common server may map the different patient IDs used by the various systems (hospital, clinic, pharmacy, etc.) to a unique ID which is used by the system 46. The aggregated data 10 may thus include demographic patient information, medical records, medical images, laboratory results, narrative doctor notes, audio recordings, current and past medications, allergies, hereditary conditions determined from family history, and the like.

Each of the records 36 may have some searchable metadata in addition to the content. The metadata may include dates and locations (e.g., when and where the analyses were done or when the prescriptions were made), information about the practitioner, ASCII transcriptions of handwritten text, etc. Alternatively or additionally, different techniques can be applied, such as scanning the document and processing the scanned document with an optical character recognition (OCR) engine, handwriting recognition, voice-to-text or other speech recognition (in the case of audio recordings), image auto-annotation, etc. to retrieve this information, where possible.

In some embodiments, unified health enterprise platforms that exist to store and access EHRs can be employed by the aggregation component 60. One example is the Caradigm™ Amalga Unified Intelligence System which allows federating EHRs stored in various systems. Other solutions for storing personal health records exist, including the Microsoft Health Vault and personal health record applications for tablets and PCs. At present, however, these unified systems are not widely used. Hence the exemplary system may aggregate information from different sources.

2. Transformation of Elements of the Patient's Medical Information into its Unique Homogeneous Form (S104)

The aggregated medical data 10 is heterogeneous. While it is possible to retrieve information from such data corresponding to a precise database query, it is difficult to retrieve the records which relate to more complex queries, such as the implicit queries used herein. For example a database of MRI records could be searched with a query corresponding to “Select all brain MRI images for patient X”, or “Select all records for patient X starting on date D1 and ending on date D2”. However, the exemplary implicit queries do not rely on such precise requests.

To perform the search, the exemplary search component 66 computes a similarity metric between the query and the individual records. To be able to establish a similarity score, both the records and the query are represented in a unique homogeneous form, e.g., as a multidimensional vector 12, 34, each element (dimension) of the vector corresponding to a respective medical-related concept. The record and query representations are generated using the same set of concepts.

In the exemplary embodiment, the representation 12 of a record (or an element of a record) is generated using a medical ontology 64 of biomedical concepts. The ontology may include at least 1000 concepts, or at least 100,000 concepts, or at least 1 million concepts, each concept corresponding to a respective dimension in the representation 12 of the patient record, i.e., the multidimensional representations 12, 34 may include at least 1000 dimensions, prior to any dimensionality reduction. The ontology 64 may include different types of concepts that are linked together. As example, the concepts may include parts and sub-parts of the human body, biological functions, diseases, syndromes, and other medical conditions, pharmacological substances, including general classes of medicines and specific examples of medicines, and other methods of treatment, and the like. As an example ontology, the Unified Medical Language System (UMLS, see http://www.nlm.nih.gov/research/umls/) designed by the US National Library of Medicine, may be employed. See, for example, Olivier Bodenreider, “The Unified Medical Language System (UMLS): integrating biomedical terminology,” Nucleic Acids Research, 32, D267-D270 (2004). UMLS is a standard medical nomenclature which includes multiple levels, some of which are available for a fee. The level 0 subset, which is available free of charge, contains over 1.8 million concepts and 17 million relations between these concepts. Such an ontology 64 can be used to represent a record 36, or one element of the record, based on information extracted from the record. The record 36 can then be indexed by its representation(s) 12.

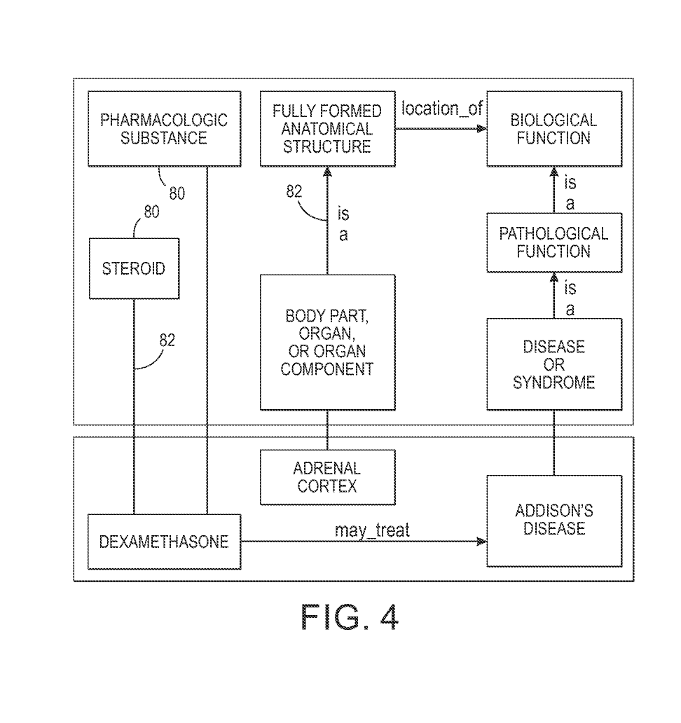

FIG. 4 illustrates a small portion of the knowledge represented in the UMLS-based ontology 64 with different types of relationships. The ontology includes a set of concepts 80, represented in FIG. 4 as blocks. Relationships 82 between the concepts 80 are represented by links, shown here as arrows and lines. The arrows denote specific types of relationships, such as may_treat, is_a, and location_of. Lines indicate subset-type links between concepts of different levels. The concepts that are less specific (higher level concepts) may be less useful and thus may be excluded from consideration in generating the representation of the record. For example, the high level concepts “fully-formed anatomical structure” and “biological function” may be ignored. In other embodiments, all the concepts in the ontology (at any given time, since the ontology is not static) may be used in generating the representation.

In some embodiments, at least some of the medical concepts 80 selected from the ontology for use in generating the representations may each be associated with a set of terms, such as synonyms (e.g., different names for a given drugs Latin names for parts of the body, common and medical names for diseases and other medical conditions, and expressions of medical conditions that strongly correlate with them). Each record 36 may also be associated with a set of terms, e.g., derived from the metadata of the record or using other extraction methods, optionally, with a measure of occurrence of the term, such as a frequency of its occurrence in the record. When a term (or set of terms) corresponding to a concept's term is found in one of the records 36, the corresponding concept can be recognized, and the matching concept represented by a value in the representation of the record, sometimes with a confidence score.

Additionally, the links 82 between concepts can be used to identify related concepts which can be used in generating the representation of the record, with directly linked and parent (higher level) concepts being more relevant than concepts which are more remote from an identified concept. In one embodiment, a concept that is related to a concept that matches a term in the record may thus be represented in the representation of the record by propagating at least some confidence level to the related concept.

A medical record 36 may contain multiple elements (or “documents”). The elements can be of the same or different modalities such as images with related textual and/or audio reports, referring to the same medical act (e.g., a pregnancy ultrasound visit or a brain scan). These elements of the record can be considered together as forming a single element, however the record can also be separated into several sub-parts (several elements). Therefore in what follows, the term “document” can refer either to an entire medical record or to only a part of the record.

In the exemplary method, each document (e.g., health record) is represented as a vector of UMLS concepts 80 where:

1: Each dimension corresponds to the unique ID of a UMLS concept (e.g., [C0001175] is the ID for the concept “Acquired Immunodeficiency Syndrome” and [C0002372] is the ID for the concept “Aluminum Hydroxide Gel”)

2: The corresponding value of the dimension may provide information about the relevance of the concept with respect to the document. In one embodiment, the value can be a scalar which ranges, for example, from 0-1. In other embodiments the value is binary, e.g., 1 if relevant, 0 if not. In some embodiments, weights are used to express confidence that the concept is relevant or not.

Building such a vector representation may involve the following steps:

S104A. The set of UMLS concepts is first extracted from the documents, possibly with a set of weights (confidence values).

S104B. The extracted ontology concepts (and weighted confidence values) are then aggregated at the document (e.g., record) level.

There are different ways to extract the UMLS concepts from a medical document (S104A), which may depend, in part on the type of document:

1. Some records may have been manually coded with UMLS terms at the time of their creation (e.g., by a practitioner, an administrative person or a system designed to add the relevant UMLS terms when creating the original medical record).

2. Records may have keywords and free text attached to their content, or the content itself can be unstructured text (for example doctors' notes).

The exemplary transformation component 62 may include a natural language parser which extracts nouns and multi-word expressions from the text portions of the records. An exemplary parser is the Xerox Incremental Parser (XIP) which is described, for example, in U.S. Pat. No. 7,058,567, issued Jun. 6, 2006, entitled NATURAL LANGUAGE PARSER, by Aït-Mokhtar, et al.; AR-Mokhtar, S., Chanod, J-P., Roux, C. “Robustness beyond Shallowness: Incremental Deep Parsing”. Natural Language Engineering 8 (2002) 121-144. Similar incremental parsers are described in Aït-Mokhtar “Incremental Finite-State Parsing,” in Proc. 5th Conf. on Applied Natural Language Processing (ANLP '97), pp. 72-79 (1997), and Aït-Mokhtar, et al., “Subject and Object Dependency Extraction Using Finite-State Transducers,” in Proc. 35th Conf. of the Association for Computational Linguistics (ACL '97) Workshop on Information Extraction and the Building of Lexical Semantic Resources for NLP Applications, pp. 71-77 (1997). The syntactic analysis performed by the parser may include the construction of a set of syntactic relations (dependencies) from an input text by application of a set of parser rules. Exemplary methods are developed from dependency grammars, as described, for example, in Mel'\check{c}uk I., “Dependency Syntax,” State University of New York, Albany (1988) and in Tesnière L., “Elements de Syntaxe Structurale” (1959) Klincksiek Eds. (Corrected edition, Paris 1969).

A specific application of the XIP parser to the medical field, which may be utilized herein, is described in Hagège C., Marchal P., Darmoni S. J., Gicquel Q., Pereira S., Metzger M-H, “Linguistic and Temporal Processing for Discovering Hospital Acquired Infection from Patient Records,” Proc. Knowledge Representation for Health-Care (KR4HC), ECAI 2010, Lisbon, Portugal, August 2010, Lecture Notes in Computer Science, Volume 6512, Pages 70-84, Springer Berlin/Heidelberg, 2011. (Hereinafter, Hagège 2010) and in “Assistant de Lutte Automatisée et de Détection des Infections Nosocomialles à partir de Documents textuels Hospitaliers (ALADIN-DTH), Development of an automated assistant to monitor Hospital Acquired Infections and A Detection System for Hospital Acquired Infections from Patient Discharge Summaries, at http://www.aladin-project.eu/index-en.html) hereinafter “ALADIN-DTH.” These last two references provide methods for extraction of named entities, particularly medical terms, which can be compared with the concepts to determine if there is a match.

The terms in the documents corresponding to UMLS concepts are identified and added to the representation 12. The concepts (dimensions of the representation) can be weighted using weighting schemes, such as term frequency-inverse document frequency (TF-IDF) or C-value/NC-value. See, Frantzi, K., Ananiadou, S., Mima, H. “Automatic Recognition of Multi-Word Terms: the C-value/NC-value Method”. International Journal on Digital Libraries, 3 (2) 115-130 (August 2000) for details of this method. These methods allow the frequency of occurrence of the terms corresponding to the concepts to be taken into account either as a value in the feature vector or as a confidence measure used to weight the value in the representation of the document.

For each text-based record (e.g., medical report, treatment, prescription, etc.) a text-based representation of the document may be generated, which can be Bag-of-Words (Concepts) representation. In one embodiment, only those concepts that have confidence scores above a given threshold, or the top N concepts, based on their confidence scores are retained.

Records that have no or limited metadata (e.g., medical images), can be automatically tagged with UMLS concepts using pre-trained classifiers (e.g., at the document level). These classifiers are trained on annotated medical data. For example, for images and scanned documents, a visual content-based statistical representation can be generated based on low level features extracted from patches of the image, such as color or gradient features. As examples of such statistical representations, a Bag-of-Visual Words or a generative model-based representation, such as a Fisher Vectors-based representation, may be used. See, for example, U.S. Pub. Nos. 2007005356, 20070258648, 20080069456, 20100092084, 20100098343, 20100189354, 20110026831, 20110091105, 20110137898, 20120045134, 20120076401, and 20120143853, the disclosures of which are incorporated herein by reference in their entireties, for methods of generating statistical representations of images which may be used to classify an image document. The representation is input to the trained classifier which outputs a confidence score for each concept. As with the text based representations, in one embodiment, only those concepts that have confidence scores above a given threshold, or the top N concepts, based on their confidence scores are retained.

The UMLS concepts which have been extracted may then be then pooled into a document level vector representation 12 (S104B), as follows:

In the case where no weight or confidence value is associated with the extracted UMLS concepts, the vector can be binary to indicate the presence of absence of a concept in the document. It can also have integer values in the case of a histogram of counts. It can have floating point values in the case where the histogram of counts is normalized, e.g., by the total number of counts (frequency histogram).

In the case where a weight or confidence value is associated to the extracted UMLS concepts, the counts can be weighted with such values (this is referred to sum or average pooling). In one embodiment, for each UMLS concept, the maximal confidence value in the considered record can be selected (this is referred to as max pooling).

Where multidimensional representations of two or more sub-parts of a record are generated, these may be aggregated to form a representation of the record as a whole or maintained separately.

### 3. Building a Query (S112)

Step S112 involves the creation of a query to search in the PHR 10. A query is said to be explicit when the healthcare professional enters a set of terms in the system using for instance a SQL expression. An example of such an explicit query could be “Select all documents related to a heart condition between dates D1 and D2”. While explicitly querying a system is useful, this is a complex task and it is desirable that this task is simplified as much as possible. On the other hand, in the medical context, healthcare professionals readily have available implicit queries to help them sift through the mass of records of a patient. These are queries which do not rely on healthcare professional entering one or more terms to narrow down the scope of responsive records for a particular patient.

As with the representations 12 of the patient records, the query 34 is represented by a corresponding multidimensional vector, which represents the concepts extracted from the query. It can be generated in the same way as for the records, described at S104.

It is assumed that the system is provided with sufficient information to uniquely identify the patient, e.g., from the name, social security number, unique medical ID, or the like. The patient's identity may be derived from the information on the patient's portable record, from information input by the healthcare provider or an assistant, or from another source, such as from a schedule of patient visits for the day. It is also assumed that the system is provided with sufficient information to uniquely identify the healthcare professional who will be reviewing the patient's record. This can be derived from information input to the system such as the healthcare provider's ID, name, or the like, or by linking the healthcare provider to a particular computing device, or from a schedule of patient visits for the day, or the like. In one embodiment, the implicit query generator 72 may include a context analyzer configured to recognize an identity of a viewer (the healthcare provider) of the graphical rendition.

Examples of information which can be used to generate implicit queries may include some or all of the following:

1. Health Care Professional Profile.

One way to generate an implicit query/rank the medical records in a PHR is according to the profile 16 of the health care provider. The profile includes information about the healthcare professional relating to a particular healthcare field. Different healthcare professionals, and especially different medical practitioners, have different areas of expertise and what is relevant to one practitioner may be irrelevant (or have less relevance) to another one. In one embodiment, the profile may be generated, at least in part, based on the healthcare professional's qualifications, e.g., according to the degrees, specializations, certifications or registrations of the healthcare professional. The qualifications may each be associated with one or more UMLS concepts, which can be represented in the implicit query 34.

In one embodiment, the health care provider profile 16 may be generated, at least in part, using the classification of the coded medical procedures which have been performed by the professional over a preceding period, such as the past few months or years. In the US, medical billing codes, such as CPT (Current Procedural Terminology) codes, developed by the AMA (American Medical Association), and/or Medicare codes may be used. These are numbers assigned to every task and service a medical practitioner may provide to a patient including medical, surgical and diagnostic services. In France, a classification referred to as “codage des actes médicaux,” which is used by the Social Security for reimbursement purposes may be used.

The reimbursement codes may each be associated with one or more UMLS concepts. A profile 16 may then be encoded as the histogram of coded medical procedure counts, which can each be represented in the implicit query 34.

In one embodiment, the profile may be based, at least in part, on the location, hospital or hospital department in which the healthcare professional works. If the hospital specializes in particular forms of treatment, this may be useful information from which UMLS concepts can be extracted, which can be represented in the implicit query 34.

2. Patient Records Acquired for a Consultation with the Healthcare Provider

The system may receive, from the healthcare provider or provider's local network, patient records that are have been acquired for a consultation which are relevant to the healthcare provider, for example, because the healthcare provider (or the provider's support staff or local computer network) generated the records and/or requested the records for use in the consultation with the patient. The patient records acquired for a consultation may include health records and other records, such as administrative records. Examples of such patient records may include:

A) Admission Form:

A patient may be asked to fill in an admission form upon arrival in a medical office or upon admission to a hospital. In such a form, the patient may describe his/her symptoms, current and past treatments, present and past drug or alcohol usage, etc. If this form is filled in electronically, then the relevant UMLS concepts can be extracted automatically. If it is in printed format, then the form may be first scanned to perform OCR processing and/or handwriting recognition before the extraction of UMLS concepts.

B) Results of an Analysis:

In some cases, the patient may come to a medical appointment with laboratory results, for example: blood tests, allergy tests, endurance tests, etc. The UMLS concepts may be extracted automatically from the results records as well as corresponding values from such tests to form an implicit query 34.

C) Records of a Previous Visit:

Similarly, it is not unusual for a patient to come to a medical appointment with the records of a previous visit, in the same medical office or in another one. For example, a patient, after a first visit to his general practitioner (GP), goes to a specialist with a description of his/her medical condition provided by the GP (e.g., a description of the symptoms). The UMLS concepts may be extracted automatically from the prior records and corresponding confidence values from such records to form an implicit query 34.

In some embodiments, the concepts extracted from the different types of implicit information (e.g., two or more of health care provider profile 16, an admission form, recent medical records, and lab results) can be considered separately and a separate query generated for each type of information. The retrieved documents for each implicit query 34 can then be aggregated. In other embodiments, the concepts identified for the different types of implicit information may be combined to generate a single implicit query.

It is to be appreciated that explicit and implicit queries need not be considered as mutually exclusive. Both can be combined into a single multidimensional representation by performing an aggregation operation (sum or max for example) over the explicit and implicit vectorial representations.

4. Ranking the Medical Records According to the Query (S114)

S114 may include computing a similarity measure between the PHR records 10, as represented by their vectorial representations 12, and the query 34, and then ranking the records based on the comparison.

Given a query, such as an implicit query or a combined explicit and implicit query, a similarity is computed between its vectorial representation and the vectorial representations of records in the patients aggregated PHR.

Computing the similarity between two UMLS vectorial representations 34, 12, corresponding to the query and medical record respectively, can be performed using a variety of similarity measures. For example, simple similarity measures, such as the Hamming distance (in the case of a binary representation), the dot-product, the Euclidean distance, or the cosine distance can be used. In the case of vectors based on UMLS, the vectors tend to be very sparse (for example, at level 0 UMLS contains at least 1.8 million concepts). In such a case, these similarity measures may be expected to perform poorly.

One solution to the sparsity is to project the data into a lower-dimensional space where the representation is denser, e.g., by performing a Singular Value Decomposition (SVD) or a Probabilistic Latent Semantic Analysis (PLSA) on the vectors. Following dimensionality reduction, simple similarity measures can then be applied in the lower-dimensional space, e.g., a Euclidean distance.

Another approach is to keep the sparse representation but to define measures between vectors which can relate different UMLS dimensions. For example, it may be assumed that the “proximity” between two concepts i and j can be measured and that it has a value Pij. Then, the matrix of proximities P for all the concepts can be used to define the following measure between two UMLS vectors x and y. x′Py, where x represents one of the record representation and the query representation, y represents the other of the record representation and the query representation, and x′represents the transpose of vector x.

A normalized similarity measure can then be obtained as follows:

$$\frac{{x}^{′} Py}{\sqrt{{x}^{′} Px} \sqrt{{y}^{′} Py}}$$

where y′represents the transpose of vector y.

To define measures of proximity Pij between UMLS concepts, a measure of the similarity between concepts can be determined. The similarity between two concepts X and Y measures “how much is X like Y”? This can be measured using the distance between the concepts in a hierarchy of concepts where the link between a parent and a child denotes a “is-a” relationship. For example, a direct link between two concepts is used to denote a high measure of proximity, whereas concepts that are spaced by two or more links, with other concepts in between them, are accorded a lower measure of proximity. For example, proximity Pij may be a function of the inverse of the number of links, optionally with concepts that are more distant than, for example, two or three links, being assigned zero or a low proximity.

Another measure of proximity may be based on the relatedness between concepts. The relatedness between two concepts X and Y measures “how much is X related to Y”? There several possible relatedness relationships between concepts including “is-a”, “part-of”, “treats”, “affects”, “symptom-of”, etc. As an example, while “tetanus” and “deep cut” are two related concepts, they are not similar (similar concepts are related but related concepts are not necessarily similar). Several similarity and relatedness measures have been proposed and compared in the literature. See, for example, Ted Pedersen, Serguei Pakhomov, Bridget McInnes, and Ying Liu, “Measuring the Similarity and Relatedness of Concepts in the Medical Domain: IHI 2012 Tutorial (2012), hereinafter “Pedersen 2012”, accessible at http://www.comp.hkbu.edu.hk/ihi2011/Documents %20-%20web2011IHI_files/IHI2012-semantic-similarity-tutorial.pdf; Siddharth Patwardhan, Ted Pedersen, “Using WordNet-based Context Vectors to Estimate the Semantic Relatedness of Concepts” in Proc. EACL 2006 Workshop on Making Sense of Sense: Bringing Computational Linguistics and Psycholinguistics Together, Trento, Italy, pp. 1-8 (2006); Pedersen, T., Pakhomov, S., Patwardhan, S., Chute, C., “Measures of Semantic Similarity and Relatedness in the Biomedical Domain,” in J. Biomedical Informatics 40: 288-299 (2007). Simple software packages exist to measure such quantities (see, Pedersen 2012). One or more of these relatedness/similarity measures can be used to generate a proximity value for each pair of concepts in the UMLS hierarchy.

Another potential issue with using a proximity matrix P to propagate similarity values to other, similar concepts is that the full matrix P may be too large to store and manipulate. One solution to this includes storing, in a sparse format, only those values Pij which are above a predetermined threshold. Another solution includes computing the Pij terms on-the-fly. Since the vectors x and y are generally very sparse, very few terms need to be computed on-the-fly. In some embodiments, the proximity matrix P may be pre-computed and stored.

As will be appreciated, any suitable measure may be employed for computing similarity between UMLS concepts and the method is not limited to those suggested herein.

Once similarity measures, such as scores, have been computed between the query and each record (or sub-part of a record where these are separately represented), the records (or more generally, documents) can be ranked based on the similarity measures. A subset of the records of the patient is then retrieved, based on the ranking, i.e., fewer than all records. For example, the top N most highly ranked records, based on the computed similarity metric between the vectors, can be retrieved. In another embodiment, only those records which meet a threshold on the similarity measure are retrieved.

### 5. Summarizing and Visualizing the Retrieved Data (S116)

Various methods for generating a graphical rendition 20 of the retrieved records (or more generally, documents) are contemplated. In some embodiments, the graphical rendition is generated by the summarization component 68 of the server computer 46. In some embodiments, a client software component on the client device 52 may perform the summarization and generation of the graphical rendition 20, based on the subset of records identified by the system.

The summarization of clinical information may include some or all of the following:

1. Split. First, each retrieved (relevant) document (record or part of record) is optionally split into individual acts (e.g., a lab results document can contain several types of blood analyses, a set of images can be split into individual images, etc.).

2. Aggregation (of the same type of data such as glycemic control or blood pressure control). Given a finite set of health-related categories, the acts (or the records if no split is performed) are grouped by their respective categories. Example categories include blood analyses, MRI images, medical reports, medical prescriptions, family history, and health habits. The splitting can be performed based on metadata of the documents, UMLS based annotations, or by trained categorizers. In some embodiments, clustering methods may be used to group the records/acts.

Within each group, the acts may be further grouped into subclasses (e.g., for lab results into glycemic controls, lipid controls, or medical prescriptions into prescriptions of amoxicillin, metoprolol, etc.)

3. Organization (e.g., grouping and sorting the numerical values by date or value). In each group and where possible, the acts, are sorted by timeline. Optionally, free text based medical reports can be parsed and searched for medical concepts and related numerical entities extracted. See, Hagège 2010 and ALADIN-DTH.

4. Reduction. (e.g., keeping only statistics, or extreme values). This includes filtering the records to identify the most salient information.

5. Transformation. (generating graphical displays, plots, charts of data). Humans are known to be able to absorb a lot of visual information in a very short time frame (50% of the cerebral cortex is for vision). To assist the practitioner, presenting the information graphically rather than textually allows the healthcare provider to absorb the information quickly. Information graphics (e.g., graphical displays, plots, charts) can thus be used to show statistics or evolution of these values over time. Similarly, for grouped acts, clickable visual icons may be based on corresponding act types (e.g., a red drop icon for blood test results).

6. Interpretation (using medical knowledge, to detect if values are in predefined and or in abnormal ranges). Optionally, if reference values are available, the system highlights values that are outside these reference values.

7. Visualization (bringing the data together in an organized manner, e.g., using tabs, drop down menus etc., for accessing data that is not visible on a first screen). Non-numeric records can be visualized using type-oriented views (i.e., where the results come from, e.g., as laboratory results, imaging studies, and medications) and time-oriented (when the data was collected, issued). The generated graphics and non-grouped records (e.g., related to family history, allergies, etc.) can be displayed based on some predefined templates. The layout of the template can be predefined and for the different views adapted visualization techniques can be used (e.g., selected from visualization models listed in http://survey.timeviz.net/) where, in addition, elements are clickable allowing the practitioner/patient to see the details from the record that provided the extracted information.

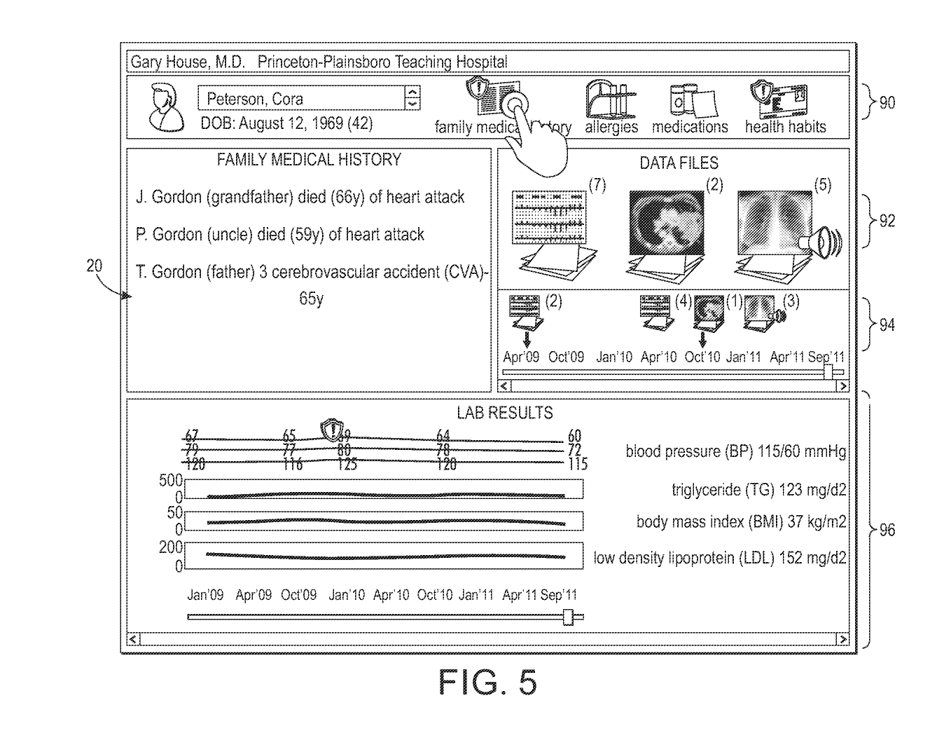

FIG. 5 illustrates an example graphical rendition of retrieved records 10 for a simulated patient, Cora Peterson. Based on the implicit information, the multidimensional vector has a high score for “congestive heart failure.” Most data is clickable and allows the practitioner to access and view the record itself. For example, a set of tabs 90 for categories of information (family medical, allergies, medications, health habits) take the healthcare provider to different screens where respective information is displayed. Or, the practitioner can access records ordered by modality, such as charts, images, and sound recordings, as illustrated by the data clusters 92. The records can also be accessed by date using a cursor to move along a timeline, as illustrated at 94. Test results for various laboratory tests are graphically represented at 96 to show the changes over time.

As will be appreciated, other summarization and visualization techniques can be used. See, for example, Feblowitz, J., Wright, A., Singh, H., Samal, L., Sittig, D. “Summarization of clinical information: A conceptual model,” J. Biomedical Informatics 44, pp. 688-699 (2011) for a discussion of a conceptual model for organizing data called AORTIS, which may be used herein. Examples of other methods for summarization and visualization are discussed in Hallett, C., 2008. “Multi-modal presentation of medical histories,” Proc. 13^{th} Intern'l Conf. on Intelligent User Interfaces (IUI '08), pp. 80-89 ACM (2008); Roque, F. S., Slaughter, L., Tkat\check{s}enko, A., “A Comparison of Several Key Information Visualization Systems for Secondary Use of Electronic Health Record Content,” Proc. NAACL HLT 2010 Second Louhi Workshop on Text and Data Mining of Health Documents, pp. 76-83 (2010); Wang, T. D., Plaisant, C., Quinn, A. J., Stanchak, R., Shneiderman, B., “Aligning Temporal Data by Sentinel Events: Discovering Patterns in Electronic Health Records,” Proc. 26th Annual SIGCHI Conf. on Human Factors in Computing Systems (CHI '08), pp. 457-466 ACM (2008); M. Blaschko and C. Lampert, “Correlational spectral clustering,” CVPR 2008; K. Chaudhuri, S. M. Kakade, K. Livescu, K. Sridharan, “Multi-View Clustering via Canonical Correlation Analysis,” Proc. 26th Annual Intern'l Conf. on Machine Learning (ICML 2009), pp. 129-136 (2009); NHS Clinical Dashboards Pilot Programme, accessible at www.hscic.gov.uk; and “HealthAdvocate Benefits Gateway Health Information Dashboard™,” accessible at: www. healthadvocate.com/downloads/solutions/health-info-dashboard.pdf, for examples of summarization and visualization techniques.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for targeted summarization of a patient's electronic medical records, comprising:
an aggregation component which provides an aggregation of health records of a patient;
a transformation component which transforms the health records of the patient into representations in a multidimensional search space;
a search component which generates an implicit query in the multidimensional search space and retrieves responsive heath records based on the implicit query;
a summarization component which generates a summary based on the retrieved responsive health records for display to a healthcare provider on an associated user interface; and
a processor which implements the aggregation component, transformation component, search component, and summarization component.

2. The system of claim 1, wherein the implicit query is based on at least one of:
a profile of the healthcare provider;
patient information acquired for a consultation with the healthcare provider.

3. The system of claim 2, wherein the implicit query is based on a profile of the healthcare provider.

4. The system of claim 3, wherein the profile of the healthcare provider comprises information relating to qualifications of the healthcare provider and wherein the implicit query includes a representation of the healthcare provider's qualifications.

5. The system of claim 3, wherein the profile of the healthcare provider comprises information relating to a plurality of medical procedures which have been performed by the professional over a preceding period and wherein the implicit query includes a representation of the performed medical procedures.

6. The system of claim 3, wherein the profile of the healthcare provider comprises information relating to a location of the healthcare provider and wherein the implicit query includes a representation of location.

7. The system of claim 2, wherein the implicit query is based on at patient information comprising least one of:
an admission form of the patient;
results of an analysis for the patient; and
records of a previous medical visit by the patient.

8. The system of claim 2, wherein the transformation component transforms each health record into at least one representation of the patient record using an ontology comprising a plurality of medical concepts.

9. The system of claim 8, wherein the ontology comprises at least one thousand medical concepts.

10. The system of claim 8, wherein each of the plurality of medical concepts corresponds to a respective dimension in the representation of the patient record.

11. The system of claim 8, wherein the ontology includes parts of the human body, biological functions, medical conditions, pharmacological substances, and combinations thereof.

12. The system of claim 9, wherein the ontology is derived from the Unified Medical Language System ontology.

13. The system of claim 8, wherein in the generating of the implicit query in the search space, the search component transforms the query into a representation of the patient record using the ontology.

14. The system of claim 1, wherein the search component computes a similarity measure between a multidimensional representation based on the implicit query and multidimensional representations of the patient records.

15. The system of claim 1, wherein in computing the similarity measure between the multidimensional representation based on the implicit query and the multidimensional representations of the patient records, the search component applies a matrix of proximities to the multidimensional representation based on the implicit query that accounts for relationships between concepts in the ontology.

16. The system of claim 1, wherein the search component retrieves responsive heath records based on the implicit query and on an explicit query.

17. The system of claim 1, wherein the search component transforms the explicit query, separately or in combination with the implicit query, into a representation in the multidimensional search space, the search component retrieving responsive heath records based on the representation.

18. The system of claim 1, wherein the patient heath records are in a plurality of different formats selected from images, text, and audio records and wherein each of the documents is represented by a representation in the same multidimensional search space.

19. The system of claim 1, wherein given the identity of the healthcare provider and the identity of the patient, the implicit query is generated without input from the healthcare provider, based on stored records.

20. The system of claim 1, wherein the summary comprises a graphical rendition of at least a part of the retrieved records.

21. A method for targeted summarization of a patient's electronic medical records, comprising:
providing an aggregation of health records of a patient;
transforming the health records of the patient into representations in a multidimensional search space;
generating an implicit query in the multidimensional search space;
retrieving responsive heath records based on the implicit query;
generating a summary based on the retrieved responsive health records for display to a healthcare provider on a user interface; and
wherein at least one of the providing an aggregation, transformation, implicit query generation, retrieval, and summary generation is implemented by a processor.

22. A computer program product comprising a non-transitory medium which stores instructions, which when implemented by a processor, performs the method of claim 21.

23. A method for targeted summarization of a patient's electronic medical records, comprising:
accessing health records of a patient;
transforming each of a collection of health records of the patient into at least one multidimensional representation based on an ontology of medical concepts, at least some of the concepts in the ontology being linked by relationship links that are used to identify related concepts;
generating an implicit query comprising a multidimensional representation based on the ontology of medical concepts;
comparing the multidimensional representation of the query with the multidimensional representations of the health records of the patient to identify a set of similar heath records based on the comparison;
summarizing the set of similar heath records to generate a graphical rendering of the similar heath records for display to the healthcare provider on a user interface; and
wherein at least one of the accessing, transformation, implicit query generation, comparison, and summary generation is implemented by a processor.
